(19) United States
(12) Patent Application Publication
(10) Pub. No.: US 2020/0170283 A1
(43) Pub. Date: Jun. 4, 2020

(54) CANNABIS EXTRACT AND JUICE HAVING IMPROVED SHELF LIFE AND METHODS THEREOF

(71) Applicant: Regenerative Foods and Juices Company, Inc., Long Beach, CA (US)

(72) Inventors: Yasir Hashim, Long Beach, CA (US); Kristofer Michael Taylor, Long Beach, CA (US)

(73) Assignee: Regenerative Foods and Juices Co., Long Beach, CA (US)

(21) Appl. No.: 16/584,620

(22) Filed: Sep. 26, 2019

Related U.S. Application Data
(60) Provisional application No. 62/748,707, filed on Oct. 22, 2018.

(51) Int. Cl. A23L 2/04; A23L 2/68; A23L 29/00; A23L 33/105; A23L 3/015; A23L 3/32; A23L 3/18

(52) U.S. Cl. CPC A23L 2/04; A23L 2/68; A23L 29/035; A23L 3/18; A23L 3/015; A23L 3/32; A23L 33/105

(57) ABSTRACT

Cannabis extract subjected to a Pulsed Electric Fields (PEF), High Temperature Short Time (HTST), Heat, High Pressure Processing (HPP) and weak acid preserves the cannabis extract. This process delays, maintains, inhibits, retards and/or reduces the rate of plant derived and/or synthetically derived cannabinoid extract deterioration or degradation and is ideally used in beverages, foods and other consumer products, including a juice product. In addition to preserving the product, the weak acids are preferably citric acid and lemon juice to both inhibit action of oxidative enzymes in the packaged product, but to also inhibit hepatic enzymes in vivo to improve the duration of bio-activity, improve bio-availability, and optimize bio-effects of cannabinoids.

### FIELD OF THE INVENTION

The present invention relates improving shelf life for cold pressed cannabis extract and juice products. In particularly, the present invention relates to inhibition of cannabinoid deterioration, microbiological spoilage and enzymatic browning of juice and/or extracts derived from Cannabis sativa l.

### BACKGROUND OF THE INVENTION

Cannabis is a plant known to remedy for multiple chronic health conditions and diseases It and is known to have prophylactic value in the prevention of various chronic conditions, particularly those associated with inflammation.

Cannabis includes analgesic, anti-inflammatory, anticancer, antibiotic, anti-anxiety, and anti-oxidant properties. Further, Cannabis has many reported health benefits due to its content of fiber, vitamins and antioxidant compounds.

During production, harvesting, preparation of cannabis extracts (for example washing, drying or trimming), and storage, the cannabinoid profile and the nutrient quality of cannabis and all the compounds associated with Cannabis may undergo changes. These changes often include a pronounced change in cannabinoid profile that can affect its health benefits for consumers and complicate any dosing regiment. These changes also induce a pronounced loss in the microbiological and antioxidant properties of cannabis and often include enzymatic browning. While some changes can benefit a consumer with a particular condition, some may not. The preservation of a desired cannabinoid profile, and other phyto-component profiles, is desired to enable the delivery of a consistent product with predictable effects.

Microbial spoilage of Cannabis plants, plant derived, and/or synthetically derived cannabinoids and extracts is also a concern in the food and beverage industry today. Cannabis plants, plant derived, and/or synthetically derived cannabinoids have varying degrees of sensitivity to microbiological spoilage depending on intrinsic factors of the plant such as pH, nutrient content (e.g., juice, vitamin, or micronutrient content), Brix, water quality (e.g., alkalinity and/or hardness), and preservatives.

There are also varying degrees of sensitivity to extrinsic factors such as temperature, light exposure, humidity and time.

Spoilage events occur when microorganisms are able to overcome the plant or its extracts intrinsic factors and grow. The microorganisms ability to overcome these hurdles can be influenced by, among other things, initial contamination levels, temperature and package integrity of the plant and it's extract against microbial spoilage cannabinoid deterioration, i.e., in the case of beverages and foods.

Microbiological spoilage of Cannabis plants, plant derived, and/or synthetically derived cannabinoids and extracts can result from one or more yeasts, bacteria, mold, and combinations of such microorganisms.

For example, Botrytiscinerea is a necrotroic fungus that affects many plant species including cannabis and is capable of spoiling both the plant and its extracts that are turned into products such as enhanced waters, juices, teas, kombuchas, carbonated beverages etc. See McPartland, J. M., et. al Contaminants of Concern in Cannabis: Microbes, Heavy Metals and Pesticides (Cannabis sativa L.—botany and biotechnology (pp. 457-474) Springer International Publishing AG 2017).

Erysiphe sp. and Podasphaera sp. are also common powdery mildews that can grow rapidly in humid and cool temperatures. See McPartland J. M. et. al. A review of Cannabis diseases (Journal of the International Hemp Association 1996). Spoilage and degradation of cannabinoid profile can manifest itself in ways such as sedimentation, off-flavors and odors, brownish discoloration, and or loss of cloud or emulsion stability.

It is important to note that enzymatic browning is also one of the more common reactions that occur in Cannabis/cannabis extracts. Enzymatic browning is one of the main oxidative reactions in Cannabis and it also occurs in food, negatively affecting the nutritional density and value, color, taste and flavor profile. See Artes, F., et. al. Physical, Physiological and Microbial Deterioration of Minimally Fresh Processed Fruits and Vegetables (Food Science and Technology International 2007). Enzymatic browning is the generation of dark pigments that is largely a consequence of the oxidation of various compounds including phenols by polyphenol oxidase (PPO). This enzymatic browning can be a big problem as it reduces product quality and appeal. It can also be a sign of cannabinoid deterioration. Enzymatic browning can occur during all stages of production and processing of Cannabis.

It is evident that there is continuing need to prevent cannabinoid deterioration, microbiological spoilage and enzymatic browning in Cannabis and cannabis extracts. One traditional method of inhibiting enzymatic browning includes the addition of chemical anti-browning agents such as styrene, benzoic acid, ascorbic acid and sorbic acid. See Iyengar, A. J., McEvily, Anti-browning agents: alternatives to the use of sulfites in foods (Trends in Food Science and Technology, 1992).

Traditional ways of protecting against microbiological spoilage of foods generally is by using chemical preservatives and/or processing techniques such as tunnel pasteurization, hot filling, and ultra-high temperature treatment (UHT) or pasteurization followed by aseptic packaging and/or pasteurizing followed by chilling. Tunnel pasteurization, hot filling, ultra-high temperature treatment (UHT) or pasteurization are not the most desirable from of protecting from microbiological spoilage as they have a tendency to adversely affect nutrient content and taste profile, among other important consumer desires.

Unfortunately, these ways of inhibiting spoilage may not lend themselves to inhibiting degradation of acid form (naturally occurring) cannabinoids, which can degrade due primarily to oxidation. Further, acid form cannabinoids vary from the oxidative byproducts (non-acid form cannabinoids) in bio-availability due to transdermal absorption rates, bio-efficacy, cannabinoid receptor responses, and other ways. For, example, tetrahyrdrocannabinol (THC) has an associated “high” reported by users undertaking oral administration, while equal amounts of tetrahydrocannabinolic acid (THC-A) may not.

In order to maintain the desired effects, achieve consistent administration and bio-effects, and nutritional profile of cannabis extract, there is a need for the preservation of Cannabis/Cannabis extract in beverages and foods. Therefore, the present invention provides a system and method for processing and treatment of Cannabis/Cannabis extract as effective in militating against factors that cause deterioration to Cannabis/Cannabis extract and juices, particularly with respect to cannabinoids, and more particularly with respect to the acid form cannabinoids found naturally in freshly cut cannabis biomass.

### SUMMARY OF THE INVENTION

The present invention includes generally new cannabis and cannabis products having desired and preserved cannabinoid profiles whilst reducing enzymatic browning and protecting against microbiological spoilage. More particularly, the invention relates to a preservative method and compositions in an amount effective to delay, maintain, inhibit, retard and/or reduce the rate of plant, plant derived and/or synthetically derived cannabinoid deterioration or degradation before, during, or after the processing of Cannabis in beverages and foods.

The invention relies upon a systematic preservation method utilizing a combination of Pulsed Electric Fields (PEF), High Temperature Short Time (HTST) pasteurization, which is sometimes termed flash pasteurization, High Hydrostatic Pressure (HPP) (defined as utilizing pressures of over 58,000 at ambient or colder temperatures) which inhibits microbes, and utilization of a food grade weak acid which it is effective to delay, maintain, inhibit, retard and/or reduce the rate of plant, plant derived and/or synthetically derived cannabinoid deterioration or degradation before, during, or after the processing of Cannabis in beverages and foods.

The present invention provides Cannabis products and methods with the improved ability to use cannabis and cannabis ingredients in food, beverages, supplements and other consumer products. It is particularly adept for making a bottled juice product, or a bottled concentrated shot beverage. In a variation of the invention, the juice or extract is dried or concentrated to be utilized as a food ingredient for dry packaged food products and snacks.

Optimally, the present invention provides cannabis products and combination of cannabis with natural agents that maintain suitable, flavoring, and nutritional properties of the cannabis extract.

In another aspect the present invention provides a method of processing cannabis/cannabis extract includes cold pressing Cannabis sativa l biomass to make a cannabis juice or cannabis extract, adding weak acid at varying degrees in an effective amount and employing one or any combination of Pulsed Electric Fields (PEF), High Temperature Short Time (HTST) and High Hydrostatic Pressure (HPP) for the integrity of the cannabinoid content in whichever form desired can be maintained to a suitable degree.

For clarity, Cannabis sativa l may fall within the legal definition of either hemp, or marijuana, or the invention may be practiced utilizing a combination of both. The present invention can utilize either dried cannabis biomass to make a cold pressed extract, or utilize freshly cut and undried cannabis biomass to make a cannabis juice. It can be appreciated that freshly cut biomass can be frozen, and unthawed to create the cannabis juice. Cannabis juice can be filtered to remove chlorophyll, waxes and inert components that adversely affect flavor prior to processing in accordance with the present invention. In this way flavor can be optimized.

It can be appreciated that the flavor profile of the product in accord with the present invention is also preserved in a consistent manner to allow for other ingredients to be added both to improve shelf life, inhibit degradation of cannabinoids and other active components, and importantly to create and maintain an optimal flavor.

In another aspect the weak acid can be incorporated before or after the variations of heat, Pulsed Electric Fields (PEF), High Temperature Short Time (HTST), and High Hydrostatic Pressure (HPP) treatment. The weak acid and the stated mechanical processing methods cooperate to improve shelf life and stability of the product in accord with the goals of the invention. The addition of the weak acid can reduce the duration needed of the electrical, temperature-based and pressure based processing steps by inhibiting active microbial density and net enzymatic activity.

In another aspect the present invention provides that by employing one or any combination of Pulsed Electric Fields (PEF), High Temperature Short Time (HTST), High Hydrostatic Pressure (HPP) and weak acid at varying degrees as an agent within a cannabis product, the integrity of the cannabinoid content in whichever form desired can be maintained to a suitable degree.

In another aspect of the invention, the present invention provides utilizing one or any combination of Pulsed Electric Fields (PEF), High Temperature Short Time (HTST), High Hydrostatic Pressure (HPP) and weak acid at varying degrees as an anti-browning agent within a cannabis product. This combination achieves a reduction in enzymatic browning, inhibition of microbiological spoilage, and stabilize the aesthetic, flavors, and nutritional properties of the cannabis product.

In another aspect, the present invention provides a cannabis product comprising a cannabis juice extract using high pressure and comprising of one or more cannabinoids, an agent comprising one or any combination of Pulsed Electric Fields (PEF), High Temperature Short Time (HTST), High Hydrostatic Pressure (HPP) and weak acid at varying degrees in effective amount to reduce degradation of the one or more cannabinoids to maintain and stabilize bio-efficacy of the cannabinoids.

In another aspect the present invention provides a method for reducing enzymatic browning of cannabis and/or a cannabis product, the method comprising providing a cannabis product including one or more polyphenols, wherein the cannabis is processed or unprocessed; adding an anti-browning agent to the cannabis, the anti-browning agent comprising one or any combination of Pulsed Electric Fields (PEF), High Temperature Short Time (HTST) pasteurization, High Hydrostatic Pressure (HPP) and weak acid addition at varying degrees in an amount effective to reduce the oxidation of the one or more phenols, or polyphenols, by polyphenol oxidase (PPO). For example, the conversion during storage of cannabidiolic acid (CBD-A) into cannabidiol (CBD) can be inhibited. Likewise the conversation during storage of tetrahydrocannabinolic acid (THC-A) into tetrahydrocannabinol (THC) can be inhibited.

Particularly useful products manufactured with the processes of the present invention includes a liquid cannabis product having an improved shelf life. The cannabis product includes a cold pressed cannabis extract solution derived from hemp including cannabidiolic acid (CBD-A) along with other cannabinoids derived from Cannabis sativa l.

The product further includes a weak acid in the solution to reduce the product pH to less than 4.5. The weak acid is selected from the group consisting of ascorbic acid, citric acid, citrus juice, vinegar and combinations thereof.

The definition of a weak acid is one that is partially dissociated into its ions in an aqueous solution or water. A strong acid, which is not a weak acid, fully dissociates into its ions in water. Other examples of a weak acids include acetic acid, formic acid, hydrocyanic acid, hydrofluoric acid, hydrogen sulfide and trichloracetic acid. While these other weak acids may not be suitable for use in food products they are presented by way of to demonstrate relative strength. The present invention contemplates only the use of food-grade weak acids, and preferably those that do not introduce flavor defects.

There are several processing method used in accordance with the present invention. In some embodiments of the invention the process fully, or partially, decarboxylates the cannabinoids into a non-acid form. In one embodiment of the invention, the cold pressed cannabis extract having been treated by High Hydrostatic Pressure (HPP), typically in the range of 58,000 PSI to 100,000 PSI to improve shelf life of the cannabis product without significantly decarboxylation of the cannabidiolic acid. More preferably, the pressure of above 80,000PSI is used, up to 1,000,000 PSI. Optimally, a pressure of 87,000 PSI is used. This pressure treatment preserves at least half of the cannabidiolic acid (CBD-A) after 90 days on the shelf as a packaged product. Refrigeration may improve the shelf life further.

Even where the cannabidiolic acid does partially degrade, it primarily degrades into cannabidiol (CBD), which may not adversely affect the product. However, degradation of CBD-A into CBD (decarboxylation) is an indicator that other components may also suffer degradation. Accordingly, the present invention can consistently yield product with a combination of cannabidiolic acid (CBD-A) and cannabidiol (CBD), where the CBD-A predominates in a greater concentration than the concentration of CBD.

Preferably, the cannabis product has a pH of between 3-4, and more preferably the cannabis product has a pH of between 3.5-3.9. Optimally the cannabis product has a pH of 3.7.

Importantly, the combination of pressurization and pH regulation cooperate to inhibit degradation of the cannabidiolic acid and thereby improve shelf life. The pressure causes microbial apoptosis and thus inhibits the same from generating enzymes that can degrade the cannabinoids and other components of the product. The pH regulation cooperates with the pressurization to yield optimal results. For example, a pressure of 87,000 PSI for sixty seconds reduces pathogens including E. Coli and listeria where the product is properly pH balanced prior to pressure treatment. Importantly, this pressure treatment does not cause cannabinoid decarboxylation of any significance.

Cannabis sativa l, is preferably hemp, having a tetrahydrocannabinol (THC) content of less than 0.3% in both the biomass utilized and in the product. In an alternate embodiment, marijuana having a greater than 0.3% THC content can be utilized yielding a tetrahydrocannabinolic acid (THC-A) product. It can be appreciated that THC and THC-A can be readily interchanged for the CBD and CBD-A of the present invention.

Preferably the packaged having a first amount of cannabidiolic acid, and after ninety days the cannabis product has a second amount of cannabidiolic acid of more than half of the first amount of cannabidiolic acid. Thus, after 90 days of storage the cannabidiolic acid predominates, and is the primary cannabinoid found in the product.

Lemon juice is the preferred weak acid because lemon juice is a food grade additive that can improve bioavailability of cannabinoids due to cytochrome p-450 enzymatic inhibition. The weak acid can be added prior to, or after the treatment via High Hydrostatic Pressure (HPP). Additionally, the cold pressed cannabis extract is flash pasteurized using a High Temperature Short Time Pasteurization, subjected to a pulsed electric field, subject to Cooling Regenerative Heating, or combinations thereof, to improve shelf life.

Preferably, the High Hydrostatic Pressure (HPP) applied is between 58,000 to 100,000PSI. More preferably, the HPP exceeds 80,000 PSI. Most preferably, the HPP is 87000PSI.

Other variations, embodiments and features of the present disclosure will become evident from the following detailed description, abstract and claims.

### BRIEF DESCRIPTION OF THE DRAWINGS

The object of the invention may be understood in more details and more particularly description of the invention briefly summarized above by reference to certain embodiments thereof which are illustrated in the appended drawings, which drawings form a part of this specification. It is to be noted, however, that the appended drawings illustrate preferred embodiments of the invention and are therefore not to be considered limiting of its scope. The invention may admit to other equally effective equivalent embodiments.

FIG. 1 is a system for processing Cannabis/Cannabis extract in accordance with an embodiment of the present invention; and

FIG. 2 is a flow diagram illustrating a method for processing Cannabis/Cannabis extract in accordance with an embodiment of the present invention.

FIG. 3 shows a graph over a 90 day period for two exemplary samples of cannabis juice cold pressed in accordance with the present invention.

### DETAILED DESCRIPTION OF THE INVENTION

The present invention will now be described by reference to more detailed embodiments. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise.

The present invention discloses Cannabis/Cannabis extracts and other Cannabis products having desired and preserved cannabinoid profiles whilst reducing enzymatic browning and protecting against microbiological spoilage.

As described herein, the present invention provides Cannabis products and methods with the improved ability to use cannabis and cannabis ingredients in food, beverage and/or other consumer products.

In some embodiments, the present invention provides a novel method for the preservation of cannabis extract.

In some embodiments, the present invention provides cannabis products and combination of cannabis with natural agents that surprisingly maintain suitable aesthetic and/or nutritional properties and maintain the cannabinoid content in whichever form desired to a suitable degree. In order to maintain the desired effects and nutritional profile of cannabis/cannabis extract, the present invention provides a method for processing and treatment of cannabis/cannabis extract has been discovered as effective in mitigating against factors that cause deterioration to cannabis/cannabis extracts.

As cannabis/cannabis extract is used for a multitude of different applications and is subject to cannabinoid degradation, microbiological spoilage and enzymatic browning (amongst other innate and external environmental factors that cause deterioration), the present invention provides a method for prevention of cannabinoid deterioration, microbiological spoilage and enzymatic browning in Cannabis/cannabis extracts.

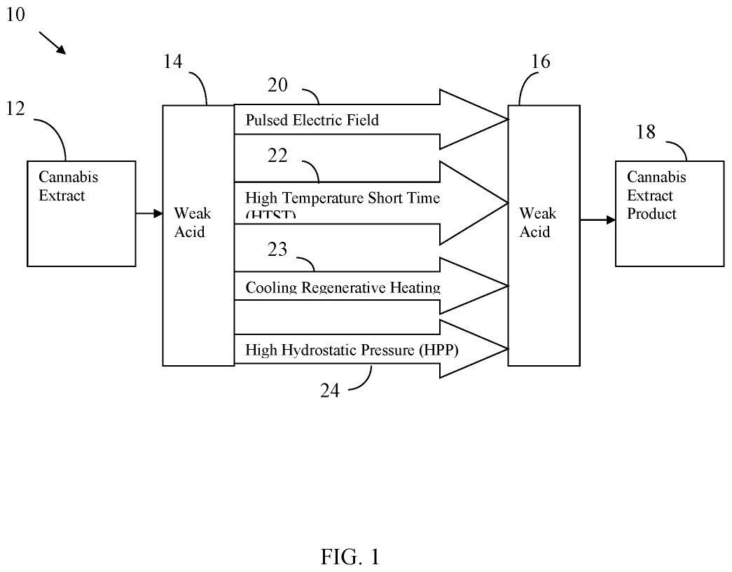

FIG. 1 illustrates a system for processing cannabis, such as a cannabis extract, according to an embodiment of present invention. The system is generally designated with the reference numeral 10. The system 10 includes providing cannabis extract 102, wherein the cannabis extract is in the form of an oil having a cannabinoid content of between 60-95% on a w:w basis. The cannabinoids primarily include cannabidiol (CBD), Tetrahydrocannabinol (THC) and a multitude (over a hundred) trace cannabinoids.

While it is preferred to begin with a processed oil extract, or dilution, it can be appreciated that a simple aqueous solution of plant biomass can be utilized in accordance with the present invention. The system 10 includes a bath for adding a weak acid 104 at varying degrees in an effective amount. The system 10 has a material processor including at least one of: a pulsed electric field generator 20, a High Temperature Short Time generator (HTST) 22, a Cooling Regenerative Heating element (23), and a High Hydrostatic Pressure generator (HPP) 24.

The system 10 transfers the mixture of weak acid and cannabis extract through one or any combination of the Pulsed Electric Fields (PEF) 106, High Temperature Short Time (HTST) 108, and High Hydrostatic Pressure (HPP) 110. The cannabis product 112 is obtained in which the integrity of the cannabinoid content in whichever form desired can be maintained to a suitable degree. In a variation of the invention, a second weak acid 16 is provided for post processing. The weak acid is not separated from the cannabis extract to create a preserved cannabis extract product 18 in one embodiment of the invention.

It can be appreciated that the acid bath 14 and 16 can be both utilized, or only a single unit be utilized. At each instance, the weak acid can be retained, or removed by filtration to optimize the process. The term bath, includes spraying the weak acid having a crystalline form suspended in an aqueous solution and mixed with the cannabis.

The cannabis extract may be a whole plant extract oil in one embodiment of the invention, or may optionally be presented in a variety of other forms including plant biomass having an optimal particle size, or a cold pressed juice of cannabis plant biomass.

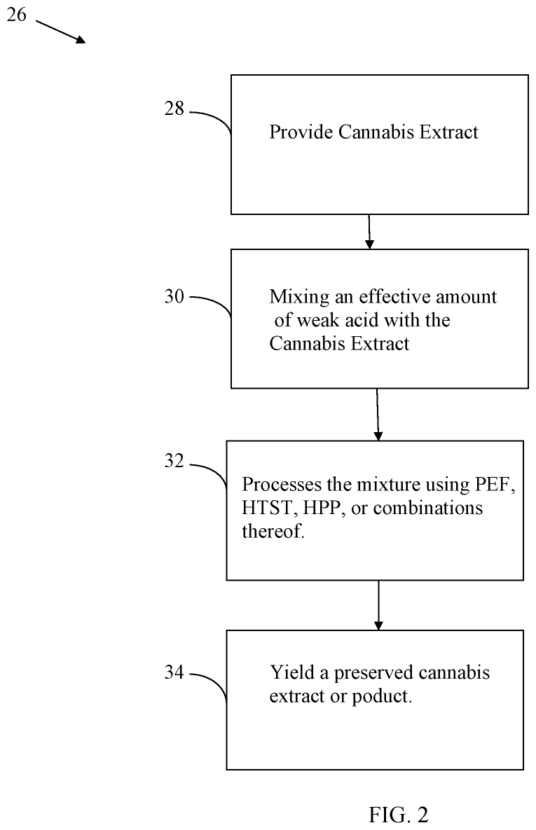

FIG. 2 is a method generally designated with the reference numeral 26. The method 26 processes cannabis, such as a cannabis extract. It can be appreciated that cannabis can be processed frozen, dry, in an aqueous slurry, mixed in an oil, mixed in a solvent, or in the form of a extracted whole plant oil (cannabis extract). Each of these manifestations of cannabis can be fortified with any cannabinoid, terpene, or other constituent derived from Cannabis sativa l. to achieve a desired cannabinoid profile, potency, or bio-efficacy. The present invention can be utilized to manufacture end products, including cannabinoids, for pharmaceutical purposes, as well as nutritional purposes as a food supplement or ingredient. Further, isolated CBD, THC or other cannabinoids can be added to supplement the products of the present invention.

The method 26 includes the step 28 of providing cannabis extract, the step 30 of mixing a weak acid in an effective amount into the cannabis extract, and the step 32 of employing one of: Pulsed Electric Fields (PEF) 106, High Temperature Short Time (HTST) 108 and High Hydrostatic Pressure (HPP) 110, or any combination thereof. These processing steps can be performed sequentially, or simultaneously, according to various aspects of the invention. The cannabis product 112 is obtained in which the integrity of the cannabinoid content in whichever form desired can be maintained to a suitable degree. The step 34 yields a preserved cannabis product that can be utilized as a nutritional supplement, or mixed as a food or beverage ingredient.

In one embodiment of the method 26, the sequence of adding acid 30 and processing 32 are reversed to process cannabis and cannabis extract according to an alternate embodiment of present invention. The method include providing cannabis/cannabis extract, and first employing one or any combination of Pulsed Electric Fields (PEF) 106, High Temperature Short Time (HTST) 108 and High Hydrostatic Pressure (HPP) 110 and next adding weak acid at varying degrees in an effective amount. The cannabis product 112 is obtained in which the integrity of the cannabinoid content in whichever form desired can be maintained to a suitable degree.

In the embodiments of the present invention incorporates pulsed electric fields (PEF) as a part of the process to maintain the integrity of cannabis extract. The use of an external electric field for a short period of time induces rapid inactivation of microorganisms by irreversibly breaking down the cell membrane. See Toepfl, S., et. al., Overview of Pulsed Electric Fields Processing for Food, Emerging Technologies for Food Processing, 2014). This technique is unconventional for cell disintegration. Possible electrochemical reactions at the electrode/media interface for PEF could include Fe(s)-Fe2+(aq)+2e−, 2H++2e−-H2(g), 2H2O—H++OH—, 4OH—O2(g)+2H2O+4e, or 2Cl-(aq)-Cl2(g)+2e−. The desired field strength for the pulsed electric fields (PEF) component of this invention can range from 2 kV/cm to 50 kV/cm.

Further, the heat is integrated into the method for preservation for cannabis extract of the present invention. The lethal effect of pulsed electric fields (PEF) is increased when the temperature of the medium is increased. See A lvarez, I., Condon, S., Raso, J., 2006. Microbial inactivation by pulsed electric Fields. In: Raso, J., Heinz, V. (Eds.), Pulsed Electric Fields Technology for the Food Industry. Fundamentals and Applications. Springer, Nueva York, pp. 97-129. This is likely due to the effect of temperature on cell membrane stability and fluidity. In the present invention, cannabis extract is the medium and heat is manipulated to achieve the desired preservative effects to the cannabis extract.

In addition to the manipulation of pulsed electric fields (PEF) and heat, the invention incorporates the use of high hydrostatic pressure (HPP). This treatment is capable of destroying most microorganisms, depending on the application conditions (amplitude of the pressure, duration time, temperature, and the mode of application), the properties of the cannabis extract (pH, nutrient composition), and the type of microorganisms or viruses. This treatment occurs above 100 MPa and can range anywhere up to 700 MPa. Pressure generation occurs through the mechanical pressure exerted on the fluid contained in the machine that processes the cannabis extract. This fluid is transmitted to a vessel where the product is already contained within its packaging and this pressure is held for a given amount of time.

It has been discovered that the preservation ability of the above described method can be increased with the addition of a weak acid. The weak acid can be incorporated before or after the variations of heat, Pulsed Electric Fields (PEF), High Temperature Short Time (HTST), and High Hydrostatic Pressure (HPP) treatment.

In one embodiment, the present invention provides that by employing one or any combination of Pulsed Electric Fields (PEF), High Temperature Short Time (HTST), High Hydrostatic Pressure (HPP) and weak acid at varying degrees as an agent within a cannabis product, the integrity of the cannabinoid content in whichever form desired can be maintained to a suitable degree.

In one embodiment, the present invention provides that utilizing one or any combination of Pulsed Electric Fields (PEF), High Temperature Short Time (HTST), High Hydrostatic Pressure (HPP) and weak acid at varying degrees as an anti-browning agent within a cannabis product, a reduction in enzymatic browning can be achieved.

Further in one embodiment, the present invention provides that utilizing one or any combination Pulsed Electric Fields (PEF), High Temperature Short Time (HTST), High Hydrostatic Pressure (HPP) and weak acid at varying degrees also aids in the reduction of microbiological spoilage.

Additionally, in one embodiment, the present invention provides that utilizing one or any combination Pulsed Electric Fields (PEF), High Temperature Short Time (HTST), High Hydrostatic Pressure (HPP) and weak acid at varying degrees also provides sustainability of the aesthetic and nutritional properties of the cannabis product.

In another embodiment, the present invention provides a cannabis product comprising a cannabis juice extract using high pressure and comprising of one or more cannabinoids, an agent comprising one or any combination of Pulsed Electric Fields (PEF), High Temperature Short Time (HTST), High Hydrostatic Pressure (HPP) and weak acid at varying degrees in an amount effective to reduce degradation of the one or more cannabinoids.

In another embodiment, the present invention provides a method for reducing enzymatic browning of cannabis and/or a cannabis product, the method comprising providing a cannabis product including one or more polyphenols, wherein the cannabis is processed or unprocessed; adding an anti-browning agent to the cannabis, the anti-browning agent comprising one or any combination of Pulsed Electric Fields (PEF), High Temperature Short Time (HTST), High Hydrostatic Pressure (HPP) and weak acid at varying degrees in an effective amount to reduce the oxidation of the one or more polyphenols by polyphenol oxidase (PPO).

Further in another embodiment, the present invention provides a method for reducing microbiological spoilage of cannabis and/or a cannabis product. The method includes providing a cannabis product comprising one or more cannabinoids, wherein the cannabis is processed or unprocessed cannabis, an agent comprising one or any combination of Pulsed Electric Fields (PEF), High Temperature Short Time (HTST), High Hydrostatic Pressure (HPP) and weak acid at varying degrees in an amount effective to reduce the spoilage of one or more microbiological compounds.

In another embodiment, the weak acid is only one of: citric acid or ascorbic acid.

In some embodiments, the present methods are suitable for use in both wet and/or dry cannabis.

While the preferred embodiments of the invention have been described above, it will be recognized and understood that various modifications may be made therein, and the appended claims are intended to cover all such modifications which may fall within the spirit and scope of the invention. In the following, the present invention is described in more detail by way of examples. However, these examples are not intended to limit the scope of protection of the present invention in any way.

### Example 1

Preservation of Cannabis Extract in the Form of Cold-Pressed Juice:

When cannabis is pressed in its wet form, pressed juice cannabis extract is the product. This pressed juice extract is vulnerable to degradation and in order to maintain the nutritional and cannabinoid integrity of the extract, the above methodology is employed. A weak acid is added to the pressed juice cannabis extract to reduce the pH to 3.7 and then it then undergoes PEF treatment (30 kV/cm for 2-5 min). After PEF treatment, the pressed juice cannabis extract is placed into packaging that can withstand high amounts of pressure and is heated to increase its temperature (A temperature increase 10%). The packaged and heated pressed juice cannabis extract then undergoes the use of high hydrostatic pressure (375 MPa pulsed for 15 minutes) to achieve the final treated pressed juice cannabis extract product. Stevia extract is added for flavor in an amount of 2.5% by volume. The product has a serving size of 55 ml, 1.48 mg of THC, and 26 mg of CBD-A. The product has less than 0.01 mg of the non-acid form of THC, and less than 0.01 mg of the non-acid form of CBD per serving.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. In the examples, the parameters set forth can vary by +/−20% in practice.

The term “cannabis” as used in this specification and the claims, unless specifically limited, includes: cannabis plant biomass, any extract thereof, any isolated cannabinoids thereof, or any combination of the foregoing. Cannabis Product means a product formulated with or derived from cannabis.

Example lab results are set forth in Tables 1-4 below are the results of lab testing of the cannabis juice cold pressed in accordance with the present invention. Each batch tested, includes product in a single serving of 50-55 ml with a density of 1-1.2 g/ml. LOD means limits of detection. LOQ means limits of quantitation. ND means not detected. CBG means cannabigerol. CBN means cannabinol. Each table 1-4 indicates initial analysis of the product of the present invention and indicates a predominance of non-decarboxilated cannabinoids, i.e. acid form cannabinoids. The total cannabinoid content is less than 1 mg/ml. Preferably the total cannabinoid content is between 0.3-1.0 mg/ml of product. In various embodiments, the CBD-A concentration is less than 1 mg/ml, and particularly, between 0.3-1.0 mg/ml.

It is noteworthy that CBD-A predominates, with a small fraction of THC-A, and no detected decarboxylated cannabinoids. Accordingly, the cold pressing process along with the addition of a weak acid preserves the acid form (non-decarboxilated) cannabinoids.

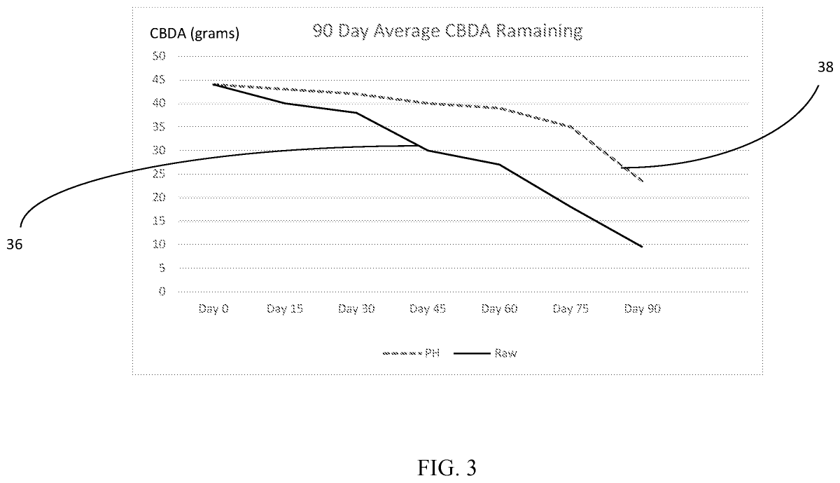

FIG. 3 shows a graph over a 90 day period for two exemplary samples of cannabis juice cold pressed in accordance with the present invention. Each sample begins with a concentration of 44 grams of CBD-A (cannabidiolic acid) per 55 ml of cold pressed juice.

The first sample 38 labelled PH represents a pH balanced sample having a pH of less than 4.7 achieved by the addition of a weak acid and being subject to high pressure processing at above 85,000 PSI. The second sample 36 is a raw sample with no added weak acid and no pressure treatment. The samples were at room temperature. The graph shows a marked improvement of the weak acid and pressure treated sample 38 over the raw (untreated sample) in terms of CBD-A content.

The tables 1-4 below are the test results for hemp juice after cold pressing, pressure treatment and addition of a weak acid. Each demonstrates a predominance of acid-form cannabinoids.

TABLE 1

| Cannab- | Mg/ | Mg/ | Mg/ | | | LOD | LOQ |
|---|---|---|---|---|---|---|---|
| inoid | mL | Serving | Package | % | mg/g | mg/g | mg/g |
| CBD | ND | ND | ND | ND | ND | 0.00121 | 0.0041 |
| CBDA | 0.55 | 30. | 30. | 0.052 | 0.52 | 0.00083 | 0.0028 |
| CBG | ND | ND | ND | ND | ND | 0.00055 | 0.00184 |
| CBN | ND | ND | ND | ND | ND | 0.00036 | 0.00121 |
| THC | ND | ND | ND | ND | ND | 0.00163 | 0.0054 |
| THCA | 0.031 | 1.69 | 1.69 | 0.0029 | 0.029 | 0.00154 | 0.0051 |
| Total | 0.58 | 32 | 32 | 0.055 | 0.55 | | |
| Measured | | | | | | | |

TABLE 2

| Cannab- | Mg/ | Mg/ | Mg/ | | | LOD | LOQ |
|---|---|---|---|---|---|---|---|
| inoid | mL | Serving | Package | % | mg/g | mg/g | mg/g |
| CBD | ND | ND | ND | ND | ND | 0.00097 | 0.0032 |
| CBDA | 0.78 | 41 | 41 | 0.075 | 0.75 | 0.00072 | 0.0024 |
| CBG | ND | ND | ND | ND | ND | 0.00174 | 0.0058 |
| CBN | ND | ND | ND | ND | ND | 0.00087 | 0.0029 |
| THC | ND | ND | ND | ND | ND | 0.00117 | 0.0039 |
| THCA | 0.042 | 2.2 | 2.2 | 0.0040 | 0.040 | 0.00103 | 0.0034 |
| Total | 0.82 | 43 | 43 | 0.079 | 0.79 | | |
| Measured | | | | | | | |

TABLE 3

| Cannab- | Mg/ | Mg/ | Mg/ | | | LOD | LOQ |
|---|---|---|---|---|---|---|---|
| inoid | mL | Serving | Package | % | mg/g | mg/g | mg/g |
| CBD | ND | ND | ND | ND | ND | 0.00122 | 0.0041 |
| CBDA | 0.38 | 20. | 20. | 0.036 | 0.36 | 0.00083 | 0.0028 |
| CBG | ND | ND | ND | ND | ND | 0.00055 | 0.00185 |
| CBN | ND | ND | ND | ND | ND | 0.00036 | 0.00121 |
| THC | ND | ND | ND | ND | ND | 0.00163 | 0.0054 |
| THCA | 0.024 | 1.30 | 1.30 | 0.0023 | 0.023 | 0.00154 | 0.0051 |
| Total | 0.40 | 21 | 21 | 0.038 | 0.38 | | |
| Measured | | | | | | | |

TABLE 4

| | Mg/ | Mg/ | Mg/ | | | LOD | LOQ |
|---|---|---|---|---|---|---|---|
| Cannabinoid | mL | Serving | Package | % | mg/g | mg/g | mg/g |
| CBD | ND | ND | ND | ND | ND | 0.00037 | 0.00122 |
| CBDA | 0.35 | 9.5 | 19.0 | 0.034 | 0.34 | 0.00103 | 0.0034 |
| CBG | ND | ND | ND | ND | ND | 0.00053 | 0.00177 |
| CBN | ND | ND | ND | ND | ND | 0.00072 | 0.0024 |
| THC | ND | ND | ND | ND | ND | 0.00113 | 0.0038 |
| THCA | 0.0164 | 0.44 | 0.88 | 0.00159 | 0.0159 | S0.00175 | 0.0058 |
| Total | 0.37 | 9.9 | 19.9 | 0.036 | 0.36 | | |
| Measured | | | | | | | |

While the present invention has been described by way of example, this description is not intended to be limiting of the invention. The scope and bounds of the invention are expressed in the appended claims.

What is claimed is:

1. A cannabis juice product having an improved shelf life, comprising;
a cold pressed cannabis extract solution including cannabidiolic acid in a concentration of less than 1 mg/ml of extract solution;
a weak acid in the solution so that the solution has a pH of less than 4.5, the weak acid is selected from the group consisting of ascorbic acid, citric acid, citrus juice, vinegar and combinations thereof;
the cold pressed cannabis extract having been treated by High Hydrostatic Pressure (HPP) in the range of 58,000 PSI to 100,000 PSI to improve shelf life of the cannabis product; and
wherein the combination of pressurization and pH regulation cooperate to inhibit degradation of the cannabidiolic acid and thereby improve shelf life of the cannabis juice product.

2. The cannabis juice product of claim 1, wherein the cannabis product has a pH of between 3-4.

3. The cannabis juice product of claim 2, wherein the cannabis product has a pH of between 3.5-3.9.

4. The cannabis product of claim 3, wherein the cannabis product has a pH of 3.7.

5. The cannabis juice product of claim 1, wherein the cannabis product is packaged having a first amount of cannabidiolic acid, and after ninety days the cannabis product has a second amount of cannabidiolic acid of more than half of the first amount of cannabidiolic acid.

6. The cannabis juice product of claim 1, wherein the weak acid is lemon juice to both adjust the pH and to inhibit oxidative action of cytochrome p450 enzymes in the cannabis juice, and inhibit action of cytochrome p450 enzymes produced by the liver in vivo.

7. The cannabis juice product of claim 6, wherein the weak acid is added before treatment High Hydrostatic Pressure (HPP).

8. The cannabis juice product of claim 7, wherein the weak acid is added after treatment of the High Hydrostatic Pressure (HPP).

9. The cannabis juice product of claim 2, wherein the cold pressed cannabis extract is flash pasteurized using a High Temperature Short Time Pasteurization.

10. The cannabis juice product of claim 2, wherein the cold pressed cannabis extract is subject to a pulsed electric field to improve shelf life.

11. The cannabis juice product of claim 2, wherein the cold pressed cannabis extract is subject Cooling Regenerative Heating to improve shelf life.

12. A method for manufacturing a cold pressed cannabis product, comprising:
providing cold pressed cannabis extract including a cannabinoid selected from the group consisting of cannabidiol, cannabidiolic acid, and combination thereof in a concentration of less than 1 mg/ml;
treating the cold pressed cannabis extract with High Hydrostatic Pressure (HPP) exceeding 80,000 PSI;
adding at least one weak acid in an effective amount to inhibit browning, and
bottling the cold pressed cannabis product.

13. The method of claim 12 further comprising:
applying a Pulsed Electric Field (PEF) to the cannabis extract to preserve the cannabis extract.

14. The method of claim 12 further comprising:
pasteurizing the cannabis extract with High Temperature Short Time (HTST) pasteurization.

15. The method of claim 12, wherein the High Hydrostatic Pressure (HPP) is used prior to the step of adding a weak acid.

16. The method of claim 12, wherein the cold pressed cannabis product has a pH of less than 4.5.

17. The method of claim 16, wherein the weak acid is lemon juice.

18. The method of claim 16, wherein the weak acid is a combination of lemon juice and ascorbic acid which cooperate to optimize the pH of the cannabis extract and to inhibit oxidative action of cytochrome p450 enzymes in the cannabis extract, and to inhibit action of cytochrome p450 enzymes produced by the liver in vivo.

19. The method of claim 16, wherein the weak acid is a combination of citrus juice and citric acid.

20. The method of claim 16, wherein the weak acid is only citrus juice.
